(19) United States
(12) Patent Application Publication
(10) Pub. No.: US 2018/0322347 A1
(43) Pub. Date: Nov. 8, 2018

(54) Driver Assistance System Featuring Adaptive Processing of Image Data of the Surroundings

(71) Applicant: Conti Temic microelectronic GmbH, Nuernberg (DE)

(72) Inventor: Markus FRIEBE, Gefrees (DE)

(21) Appl. No.: 15/773,224

(22) PCT Filed: Oct. 26, 2016
(86) PCT No.: PCT/DE2016/200493

§ 371 Date: May 3, 2018

(30) Foreign Application Priority Data
Nov. 24, 2015 (DE) 10 2015 223 175.5

(51) Int. Cl. G06K 9/00; G06K 9/32; H04N 5/262; G06T 7/60; G06K 9/62; G06T 7/50; B60R 1/00; B60W 50/14

(52) U.S. Cl. CPC G06K 9/00791; G06K 9/3233; H04N 5/2624; G06T 7/60; G06T 11/001; G06T 7/50; B60R 1/00; B60W 50/14; G06T 2207/20024; G06K 9/6267

(57) ABSTRACT

A driver assistance system for displaying an image of the surroundings for a vehicle having a vehicle camera which produce camera images of the surroundings of the vehicle, and having a data processing unit which combines the camera images produced by the vehicle cameras to form an image of the surroundings of the vehicle, wherein an associated region of interest (ROI) is processed adaptively for at least one object contained in the image of the surroundings.

The invention relates to a method and a device for processing image data of an image of the surroundings of a vehicle.

Vehicles, in particular road vehicles, increasingly have driver assistance systems which support drivers during the performance of driving maneuvers. Such driver assistance systems have a display or respectively a display panel which displays an image of the surroundings of his vehicle to the driver. Such an image of the surroundings can display a panoramic view of the surroundings situated around the vehicle, for example from a bird's eye perspective. In order to produce such an image of the surroundings, the vehicle has vehicle cameras on various sides of the bodywork, which vehicle cameras supply camera images. These camera images are combined by a data processing unit to form an image of the surroundings or respectively a panoramic view of the vehicle surroundings. This combined image is subsequently displayed on a display unit of the driver assistance system.

In many cases, objects or respectively obstacles, for example buildings or other vehicles, which result in distortions in the displayed images of the surroundings are located in the surroundings of the vehicle. These distortions can, for example, result in a miscalculation of the traffic situation by the driver of the vehicle and, consequently, adversely affect safety during the performance of the driving maneuvers.

It is therefore an object of the present invention to create a driver assistance system and a method for processing image data of the image of the surroundings, during which processing image distortions caused by objects in the displayed image of the surroundings are extensively avoided or respectively eliminated.

This object is achieved according to the invention by a driver assistance system having the features indicated in claim 1.

Accordingly, the invention creates a driver assistance system for displaying an image of the surroundings for a vehicle, having vehicle cameras which produce camera images of the surroundings of the vehicle; and having

a data processing unit which combines the camera images produced by the vehicle cameras to form an image of the surroundings of the vehicle,

wherein an associated region of interest is processed adaptively for at least one object contained in the image of the surroundings.

In one possible embodiment of the driver assistance system according to the invention, the combined image of the surroundings having the processed regions of interest is displayed on a display unit of the driver assistance system.

In another possible embodiment of the driver assistance system according to the invention, the region of interest associated with an object is formed by a polygon, the vertices of which are coordinates of a two-dimensional or three-dimensional coordinate system of the vehicle.

In another possible embodiment of the driver assistance system according to the invention, the region of interest associated with an object is determined by an environmental data model of the surroundings of the vehicle.

In another possible embodiment of the driver assistance system according to the invention, the region of interest associated with an object is specified by a user of the driver assistance system by means of a user interface.

In another possible embodiment of the driver assistance system according to the invention, the region of interest associated with an object is filtered.

The associated region of interest for the object can, for example, be high-pass or low-pass filtered.

In another possible embodiment of the driver assistance system according to the invention, the region of interest associated with an object is covered with a predefined texture.

In another possible embodiment of the driver assistance system according to the invention, an object contained in the image of the surroundings is identified based on a height profile of the surroundings of the vehicle, which is captured by sensors.

In another possible embodiment of the driver assistance system according to the invention, an object contained in the image of the surroundings is classified by the data processing unit and the subsequent adaptive image processing of the region of interest associated with the respective object is effected by the data processing unit as a function of the established class of the object.

In another possible embodiment of the driver assistance system according to the invention, the adaptive image processing of the region of interest associated with an object is effected as a function of a distance of the region of interest from a coordinate origin of a two-dimensional or three-dimensional vehicle coordinate system by the data processing unit of the driver assistance system.

The invention additionally creates a method for processing image data of an image of the surroundings of a vehicle having the features indicated in claim 11.

Accordingly, the invention creates a method for processing image data of an image of the surroundings of a vehicle, having the steps of:

Combining camera images which are produced by cameras of a vehicle to form an image of the surroundings of the vehicle, and

Performing an adaptive image processing for at least one region of interest which belongs to an object contained in the combined image of the surroundings.

In one possible embodiment of the method according to the invention, the combined image of the surroundings having the adaptively processed regions of interest of the various objects is displayed on a display unit.

In another possible embodiment of the method according to the invention, the region of interest associated with an object is formed by a polygon, the vertices of which are formed by coordinates of a two-dimensional or three-dimensional coordinate system of the vehicle.

In another possible embodiment of the method according to the invention, the region of interest associated with an object is determined by an environmental data model of the surroundings of the vehicle.

In another possible embodiment of the method according to the invention, the region of interest associated with an object is specified by a user of the driver assistance system by means of a user interface.

In another possible embodiment of the method according to the invention, the region of interest associated with an object is filtered, in particular high-pass or low-pass filtered.

In another possible embodiment of the method according to the invention, the region of interest associated with an object is covered with a predefined associated texture.

In another possible embodiment of the method according to the invention, an object contained in the image of the surroundings is identified based on a height profile of the surroundings of the vehicle, which is captured by sensors.

In another possible embodiment of the method according to the invention, an object contained in the image of the surroundings is initially classified.

In another possible embodiment of the method according to the invention, adaptive image processing of the region of interest associated with an object is effected as a function of the established class of the object.

In another possible embodiment of the method according to the invention, the adaptive image processing of the region of interest associated with an object is effected as a function of a distance of the region of interest or of the associated object from a coordinate origin of a two-dimensional or three-dimensional coordinate system of the vehicle.

Possible embodiments of the method according to the invention and of the driver assistance system according to the invention are explained in greater detail below, with reference to the appended figures, wherein:

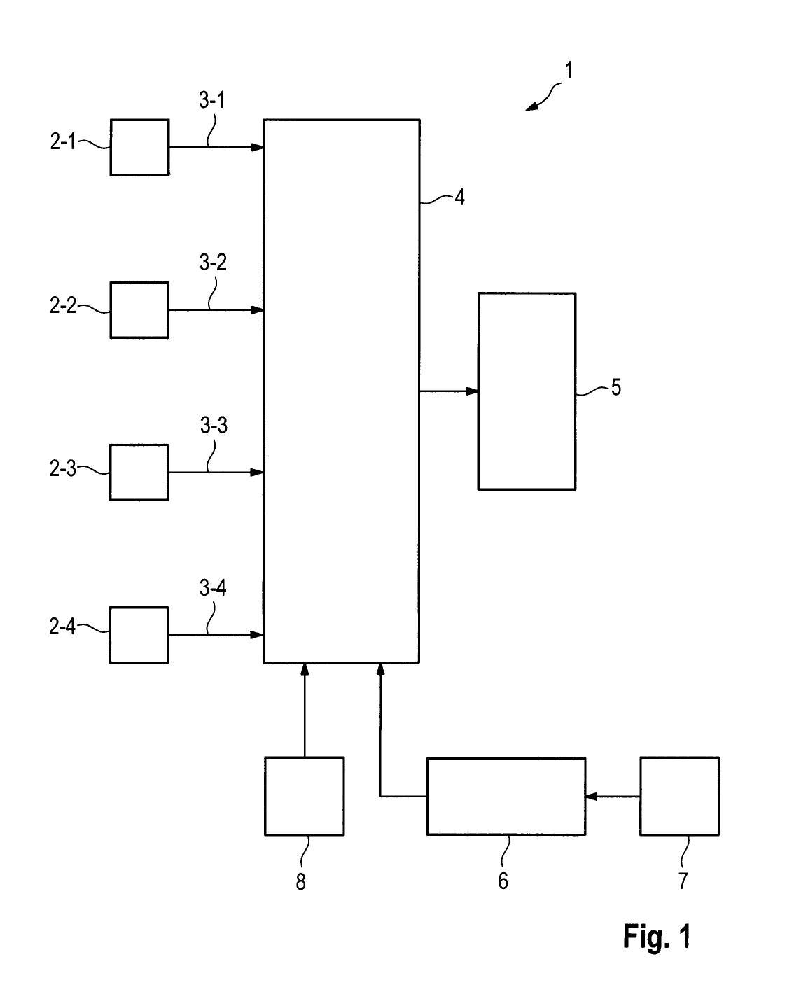

FIG. 1 shows a block diagram in order to represent an embodiment example of a driver assistance system according to the invention for displaying an image of the surroundings;

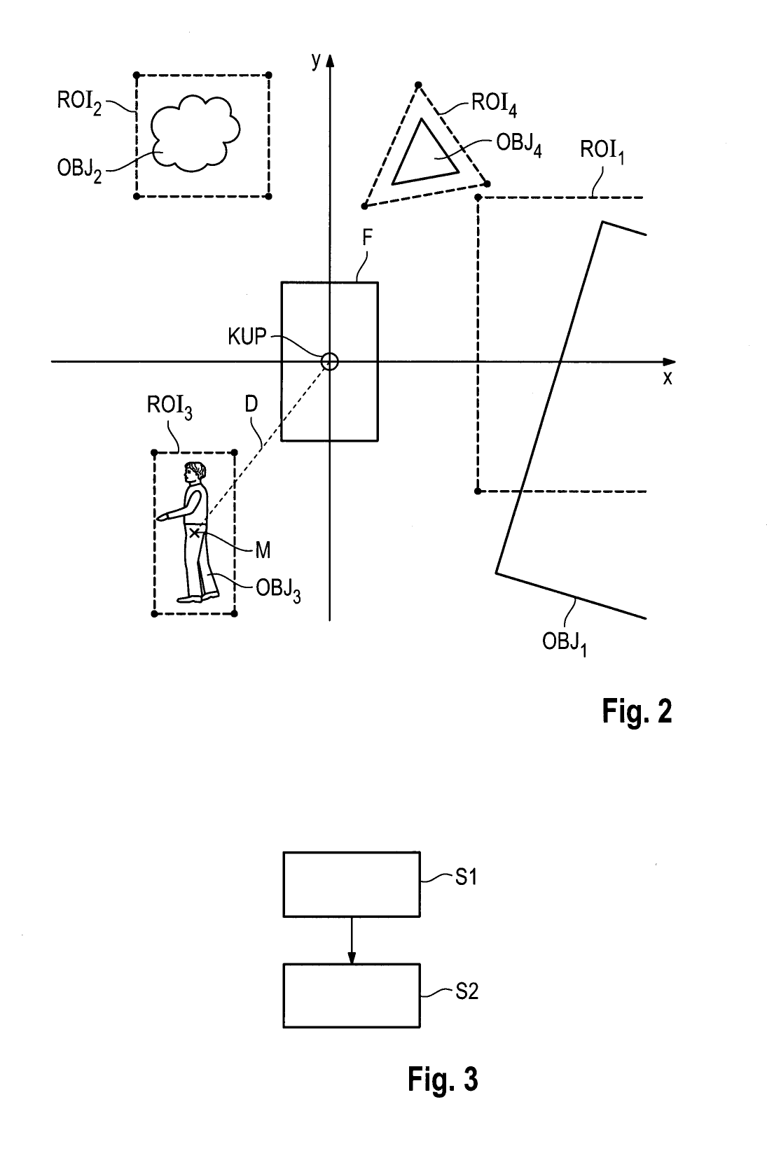

FIG. 2 shows a schematic representation in order to explain the mode of operation of the driver assistance system according to the invention and of the method according to the invention for processing image data of an image of the surroundings of the vehicle;

FIG. 3 shows a simple flowchart in order to represent an embodiment example of the method according to the invention for processing image data.

FIG. 1 shows a block diagram in order to represent an exemplary embodiment example of a driver assistance system 1 according to the invention for displaying an image of the surroundings for a vehicle. The driver assistance system 1 represented in FIG. 1 can, for example, be provided in a road vehicle, as represented schematically above in FIG. 2. In the embodiment example represented in FIG. 1, the vehicle has a plurality of vehicle cameras or respectively optical sensors 2-1, 2-2, 2-3, 2-4 which are mounted on various sides of the bodywork of the vehicle. The number of vehicle cameras provided can vary for various vehicles. In one possible embodiment, the vehicle comprises four vehicle cameras which are provided on various sides of the vehicle bodywork. In this case, one vehicle camera is, in each case, preferably provided on each side of the vehicle bodywork, i.e. a first vehicle camera 2-1 on the front side of the vehicle bodywork, a second vehicle camera 2-2 on the left side of the vehicle bodywork, a third vehicle camera 2-3 on the right side of the vehicle bodywork and a fourth vehicle camera 2-4 on the rear side of the vehicle bodywork. The various vehicle cameras 2-i continually supply camera images of the vehicle surroundings, which are transferred via signal lines 3-1, 3-2, 3-3, 3-4 to a data processing unit 4 of the driver assistance system 1. In one possible embodiment, the vehicle cameras 2-i have data encoders in order to transfer the camera images in an encoded form via the signal lines 3-i to the data processing unit 4. The data processing unit 4 has, in one possible embodiment, one or more processors for processing image data. The data processing unit 4 continuously combines the received camera images originating from the vehicle cameras 2-i to form an image of the surroundings of the vehicle. In this case, an associated region of interest is processed adaptively for at least one object contained in the image of the surroundings. The associated region of interest ROI is subjected to an adaptive image processing by the data processing unit 4. The image of the vehicle surroundings combined by the data processing unit 4 is displayed with the processed regions of interest contained therein on a display unit 5 of the driver assistance system 1.

The region of interest ROI associated with an object is preferably formed by a polygon having a plurality of vertices. For example, the polygon can be a quadrangle with four vertices or a triangle with three vertices. The vertices of the polygon are, in this case, preferably formed by coordinates of a coordinate system of the vehicle. This vehicle coordinate system preferably has its coordinate point of origin KUP in the middle of the vehicle F, as schematically represented in FIG. 2. FIG. 2 shows a two-dimensional vehicle coordinate system with a first vehicle coordinate x and a second vehicle coordinate y. In a preferred alternative embodiment, the coordinate system of the vehicle F can also include a three-dimensional vehicle coordinate system with three vehicle coordinates x, y, z.

In one possible embodiment of the driver assistance system 1 according to the invention, the region of interest ROI associated with an object is determined by an environmental data model of the surroundings of the vehicle. This environmental data model is, for example, produced by an environmental data model generator 6. To this end, the environmental data model generator 6 is connected to at least one environmental data sensor 7, for example ultrasonic sensors. These sensors supply data with respect to the height profile of the surroundings of the vehicle. For example, a curbside or a building is identified as an object or respectively vehicle obstacle, and the height of the object established by sensors is established relative to a reference level, for example the road level. The environmental data model generator 6 generates an environmental data model from the received sensor data, wherein the data processing unit 4 identifies objects in the combined image of the surroundings as a function of the produced environmental data model and determines or respectively calculates regions of interest associated with the identified objects in the image of the surroundings.

Alternatively, the regions of interest associated with the objects can be specified or respectively selected by a user of the driver assistance system 1 by means of a user interface 8 of the driver assistance system 1. In one possible embodiment, the driver assistance system 1 has a touchscreen display 5 for displaying the combined, processed image of the surroundings with a user interface integrated therein in order to select regions of interest ROI in the image of the surroundings.

In one possible embodiment of the driver assistance system 1 according to the invention, a region of interest ROI associated with an object is automatically filtered, for example high-pass filtered or low-pass filtered. The filtering of the image data of the combined image of the surroundings in the specified regions of interest is effected by the data processing unit 4 in accordance with an adaptive image data processing algorithm.

In an alternative embodiment, a region of interest associated with an object can also be covered with a predefined texture. In one possible embodiment, the user is able to configure the corresponding texture or respectively select it from a group of predefined textures.

In another possible embodiment of the driver assistance system 1 according to the invention, an object contained in the image of the surroundings, for example a building or a tree, is classified and the subsequent adaptive image processing of the region of interest associated with the object is effected as a function of the established class of the object. In another possible embodiment of the driver assistance system 1 according to the invention, the adaptive image processing of the region of interest ROI associated with an object is effected by the data processing unit 4 as a function of a distance of the respective region of interest from the coordinate origin KUP of the vehicle coordinate system of the respective vehicle F. For example, regions of interest ROI, which are located further away from the coordinate origin KUP, are subjected to a different image data processing algorithm than regions of interest ROI which are located closer to the coordinate origin KUP of the vehicle coordinate system.

FIG. 2 serves to explain the mode of operation of the driver assistance system 1 according to the invention and of the method according to the invention for processing image data of the image of the vehicle surroundings. In FIG. 2, a vehicle F is schematically represented which has a driver assistance system 1 according to the invention. In the middle of the vehicle F, for example a road vehicle, there is located a coordinate origin KUP of a two-dimensional or three-dimensional vehicle coordinate system. In the example represented in FIG. 2, various objects OBJ1, OBJ2, OBJ3, OBJ4 are located in the surroundings of the vehicle F. The object OBJ1 is, for example, a building in the surroundings of the vehicle F. The object OBJ2 is, for example, a tree which is located at the front on the left ahead of the vehicle F. Furthermore, a mobile object OBJ3 in the form of a pedestrian is represented in FIG. 2. Finally, a fourth object OBJ4 which constitutes a triangular obstacle, for example a barrier or the like, is represented in FIG. 2. An associated region of interest ROI1, ROI2, ROI3, ROI4 is determined for each of the various objects OBJ1, OBJ2, OBJ3, OBJ4. The associated region of interest is either established automatically on the basis of a generated environmental data model of the vehicle surroundings or manually by means of an input by a user of the driver assistance system 1 by means of a user interface 8. In another possible embodiment, the associated regions of interest are partially determined on the basis of an environmental data model and partially entered by a user by means of a user interface 8. The objects located in the vehicle surroundings can include fixed objects, for example buildings, trees or barrier units, but also movable objects, for example pedestrians or other vehicles in the surroundings of the vehicle F. The associated regions of interest ROI can enclose the relevant objects, for example the regions of interest ROI2, ROI3 and ROI4, or only partially cover said regions such as, for example, the region of interest ROI1. In a preferred embodiment of the driver assistance system 1 according to the invention, the associated regions of interest ROI are formed by polygons having a plurality of corners or respectively vertices, which are coordinates of the two-dimensional or three-dimensional vehicle coordinate system. The polygonal regions of interest include, for example, two, three, four or more vertices of a two-dimensional polygon or of a two-dimensional polygonal body. In one possible preferred embodiment, the number of the vertices or respectively the form of the polygon or of the polygonal body is extrapolated from the respective object. In one possible embodiment, an object OBJ contained in the image of the surroundings is classified. For example, the object OBJ2 in the represented example is classified as a tree. Furthermore, the object OBJ1 can, for example, be classified as a rigid building. Depending on the established class of the object OBJ, the form of the associated region of interest can be extrapolated in one possible embodiment. For example, if the object OBJ4 is classified as a triangular barrier, a triangular associated region of interest ROI4 is established. In another preferred embodiment of the driver assistance system 1 according to the invention and of the method according to the invention for processing image data, the adaptive image processing of the region of interest ROI associated with the object OBJ is likewise effected as a function of the established class of the object OBJ by the data processing unit 4. For example, the region of interest ROI2 of the object classified as a tree (object OBJ2) can be subjected to a first image data processing algorithm, while the region of interest ROI3 of the classified object OBJ3 (pedestrian) is subjected to another image data processing algorithm. For example, the region of interest ROI2 of the object OBJ2 (tree) can be high-pass filtered by the data processing unit 4, while the classified object OBJ3 (pedestrian) is low-pass filtered. Furthermore, the object OBJ1 which is classified as a building can, for example, be covered with an associated building texture, for example shaded in red or the like. Various textures can be allocated to various types of object or respectively classes of object. For example, in one possible embodiment, the data processing unit 4 of the driver assistance system 1 accesses a configuration data store, in which various texture patterns or respectively texture surfaces are assigned to various types of object. In another possible embodiment, the user of the driver assistance system 1 is able, by means of the user interface 8, to configure the texture patterns and/or region of interest algorithms for various objects in a way that suits him.

In another possible embodiment of the driver assistance system 1 according to the invention and of the method according to the invention for processing image data, the adaptive image processing of the region of interest ROT associated with an object OBJ is effected as a function of a distance of the respective region of interest from the coordinate origin KUP of the vehicle coordinate system. For example, the region of interest ROI4 which is situated closer to the coordinate origin KUP than the region of interest ROI1 of the object OBJ1 (building), which is situated a little further away, is treated with a first image data processing algorithm. In one possible embodiment, an object, for example the object OBJ3 (pedestrian), can move in the coordinate system of the vehicle, wherein the respective object OBJ approaches the coordinate origin KUP of the vehicle coordinate system or moves away from the coordinate origin KUP of the vehicle coordinate system. In one possible embodiment of the method according to the invention and of the driver assistance system 1 according to the invention, a distance or respectively a displacement D between a midpoint M of a region of interest ROI, which belongs to a movable object, and the coordinate origin KUP is calculated. The image data processing of the image data contained regarding the associated region of interest ROI4 is subsequently preferably effected as a function of the calculated distance D. If, during travel, the vehicle F moves relative to fixed objects, for example buildings, such a distance D from the midpoint M of the respective region of interest can be continually calculated, in order to switch over between various image processing algorithms as a function of the calculated distance D. The vehicle cameras 2-i of the vehicle F supply a stream of camera images or respectively image frames to the data processing unit 4 of the driver assistance system 1. In one possible embodiment, the associated region of interest ROI of an object OBJ changes for each new image frame in the image frame sequence, which the data processing unit 4 of the driver assistance system 1 receives from a vehicle camera 2-i.

The vehicle F, which has the driver assistance system 1, can be a road vehicle in road traffic. Furthermore, it is possible for a moving vehicle to be equipped with such a driver assistance system 1 within industrial production. Further possible applications are in the medical field. The image data supplied by the camera images or respectively camera images are combined in a so-called stitching to form a combined image of the surroundings, for example a 360° view, wherein the camera images are preferably projected onto a projection surface, in particular a two-dimensional base surface or a three-dimensional dish-shaped projection surface, in order to display them. The image data processing algorithm used in the various regions of interest, for example high-pass filtering or low-pass filtering, is preferably effected as a function of the established displacement of the vehicle coordinate origin from the associated object or respectively obstacle in the vehicle surroundings.

FIG. 3 shows a simple flowchart in order to represent an embodiment example of the method according to the invention for processing image data of an image of the surroundings of the vehicle F.

In a first step S1 camera images, which originate from various cameras of a vehicle, are combined to form an image of the surroundings of the vehicle. Subsequently, image data for at least one region of interest which belongs to an object contained in the combined image of the surroundings is adaptively processed in a step S2. The method represented in FIG. 3 is performed, for example, by a processor of an image data processing unit 4 of a driver assistance system 1.

1. A driver assistance system for a vehicle, for displaying an image of surroundings of the vehicle, comprising:
vehicle cameras configured to produce camera images of the surroundings of the vehicle;
a data processing unit configured to combine the camera images produced by the vehicle cameras to form a combined image of the surroundings of the vehicle, and configured to adaptively filter a region of interest associated with at least one object contained in the combined image of the surroundings; and
a display unit configured to display the combined image of the surroundings including the adaptively filtered region of interest.

2. (canceled)

3. The driver assistance system according to claim 1, wherein the region of interest associated with the at least one object is formed by a polygon, vertices of which are coordinates of a coordinate system of the vehicle.

4. The driver assistance system according to claim 1, wherein the region of interest associated with the at least one object is determined by an environmental data model of the surroundings of the vehicle.

5. The driver assistance system according to claim 1, further comprising a user interface configured so that the region of interest associated with the at least one object is specified by a user of the driver assistance system via the user interface.

6. The driver assistance system according to claim 1, wherein the data processing unit is configured to adaptively filter the region of interest by high-pass filtering or low-pass filtering.

7. The driver assistance system according to claim 1, wherein the region of interest is covered with a predefined associated texture.

8. The driver assistance system according to claim 1, further comprising sensors configured to capture a height profile of the surroundings of the vehicle, wherein the at least one object contained in the combined image of the surroundings is identified based on the height profile of the surroundings of the vehicle.

9. The driver assistance system according to claim 1, wherein the data processing unit is configured to classify, into a determined class, a classified object among the at least one object contained in the combined image of the surroundings, and the adaptive filtering of the region of interest by the data processing unit is effected as a function of the determined class of the classified object.

10. The driver assistance system according to claim 1, wherein the data processing unit is configured to perform the adaptive filtering of the region of interest as a function of a distance of the region of interest and/or of the at least one object from a coordinate origin of a vehicle coordinate system.

11. A method of processing and displaying image data of an image of surroundings of a vehicle in a driver assistance system of the vehicle, comprising the steps:
(a) combining camera images, which are respectively produced by cameras of the vehicle, to form a combined image of the surroundings of the vehicle;
(b) performing an adaptive filtering of a region of interest associated with at least one object contained in the combined image of the surroundings; and
(c) displaying the combined image of the surroundings including the adaptively filtered region of interest on a display unit of the driver assistance system of the vehicle.

12. The method according to claim 11, wherein the region of interest associated with the at least one object is formed by a polygon, vertices of which are formed by coordinates of a coordinate system of the vehicle.

13. The method according to claim 11, further comprising determining the region of interest associated with the at least one object by an environmental data model of the surroundings of the vehicle.

14. The method according to claim 11, wherein the adaptive filtering of the region of interest comprises high-pass or low-pass filtering.

15. The method according to claim 11, further comprising capturing a height profile of the surroundings of the vehicle with sensors, and identifying the at least one object contained in the combined image of the surroundings based on the height profile of the surroundings.

16. The method according to claim 11, further comprising classifying, into a determined class, at least one classified object among the at least one object contained in the combined image of the surroundings, wherein the adaptive filtering of the region of interest is effected as a function of the determined class of the classified object.

17. The method according to claim 11, wherein the adaptive filtering of the region of interest is effected as a function of a distance of the region of interest or of the at least one object from a coordinate origin of a coordinate system of the vehicle.

18. The method according to claim 11, further comprising determining the region of interest associated with the at least one object by receiving a specification thereof input by a user via a user interface of the driver assistance system.

19. The method according to claim 11, further comprising covering the region of interest with a predefined associated texture.
